(19) United States
(12) Patent Application Publication
(10) Pub. No.: US 2023/0162257 A1
(43) Pub. Date: May 25, 2023

(54) RECOMMENDATION ENGINE USING TEXTUAL CATEGORICAL AND USER ACTIVITY DATA

(71) Applicant: SAP SE, Walldorf (DE)

(72) Inventors: Jagroop BHAGAT, Jaipur (IN); Lohit GHONGADI, Bangalore (IN); Gyan PRAKASH, Jehanabad (IN)

(21) Appl. No.: 17/453,575

(22) Filed: Nov. 23, 2021

(51) Int. Cl. G06Q 30/06; G06F 17/16

(52) U.S. Cl. CPC G06Q 30/0631; G06Q 30/0643; G06Q 30/0627; G06F 17/16

(57) ABSTRACT

Systems and methods include determination of a plurality of items, each of the plurality of items associated with a plurality of categorical attributes and one or more values of each of the categorical attributes, and with one or more textual attributes and text of each of the one or more textual attributes, determination of a similarity value for each pair of items based on the number of categorical attribute values common to both items of the pair and the total number of categorical attribute values associated with each item of the pair for each of the plurality of categorical attributes, and on the similarity between the text of each item of the pair for each of the one or more textual attributes, and determination of one or more recommended items based on the determined similarity values.

### BACKGROUND

Traditional computing system architectures include one or more servers executing applications which access data stored in one or more database systems. The servers may be located on-premise and/or in a cloud-based datacenter. Users may interact with such applications to view, create and update the data in accordance with functionality provided by the applications.

Due to the sophistication and plethora of options provided by modern applications, it is often desirable to guide a user's selection of an item or option provided by an application. An application may present such guidance to a user as a recommendation. In one non-exhaustive example, a user may operate an online shopping application to browse for products and the application may present one or more recommended products to the user during the browsing. In another example, an application presents recommended software add-ons to a system administrator. The recommended products and add-ons may be determined by the application or by a recommendation service which is accessed by the application.

The determination of recommendations is generally based on the identification of common characteristics between a first item (e.g., a product viewed by a user) and candidate items (e.g., all other available products). Characteristics may comprise categorical and/or free text data, for example, and therefore require systems for establishing similarities based on multiple disparate data types. Characteristics may also include user activity with respect an item, which further complicates the determination of similarities on which to base recommendations.

Systems are desired to facilitate the determination of the recommendations based on categorical, textual, and user activity data.

### BRIEF DESCRIPTION OF THE DRAWINGS

FIG. 1 is a block diagram of an architecture to determine item recommendations and provide item recommendations to a user according to some embodiments.

FIG. 2 is a tabular representation of item metadata according to some embodiments.

FIG. 3 is a similarity matrix determined according to some embodiments.

FIG. 4 is an updated similarity matrix according to some embodiments.

FIG. 5 is a user activity matrix according to some embodiments.

FIG. 6 is an updated user activity matrix according to some embodiments.

FIG. 7 is a flow diagram of a process to determine item recommendations according to some embodiments.

FIG. 8 is a user interface for browsing items according to some embodiments.

FIG. 9 is a user interface showing item metadata according to some embodiments.

FIG. 10 is a user interface showing recommended items according to some embodiments.

FIG. 11 illustrates determination of user activity-based similarity scores according to some embodiments.

FIG. 12 is a user interface for browsing items by a known user according to some embodiments.

FIG. 13 is a user interface showing item metadata to a known user according to some embodiments.

FIG. 14 is a block diagram of a hardware system to determine and provide item recommendations according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments provide a graph-based recommendation system which efficiently considers item metadata and/or user activity data to generate filterable item recommendations. Embodiments may support the addition of new items and new users without requiring regeneration of an entire graph. A recommendation system according to some embodiments is customizable based on existing and future requirements.

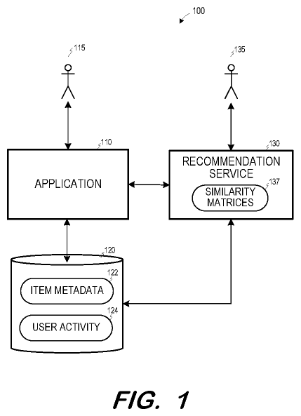

FIG. 1 is a block diagram of an architecture of system 100 according to some embodiments. The illustrated elements of system 100 may be implemented using any suitable combination of computing hardware and/or software that is or becomes known. Such a combination may include implementations which apportion computing resources elastically according to demand, need, price, and/or any other metric. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service).

Application 110 may comprise any suitable software application providing functionality one or more users such as user 115. Application 110 may be a component of a suite of applications provided by an application provider. Application 110 may be executed by an application platform comprising an on-premise, cloud-based, or hybrid hardware system providing an execution platform and services to software applications. Such an application platform may comprise one or more virtual machines executing program code of an application server. All software applications described herein may comprise program code executable by one or more processing units (e.g., Central Processing Units (CPUs), processor cores, processor threads) of an application platform to provide various functions.

Application 110 may provide such functions in conjunction with database system 120, which may be standalone, distributed, in-memory, column-based and/or row-based as is known in the art. Database system 120 may comprise any query-responsive system for persisting data. Database system 120 may be implemented by a database server including a database management system (not shown) providing functions for configuration, maintenance, monitoring, etc. of the data stored therein. In this regard, the data stored in database system 120 may comprise database tables conforming to a schema defined by metadata which is also stored in database system 120.

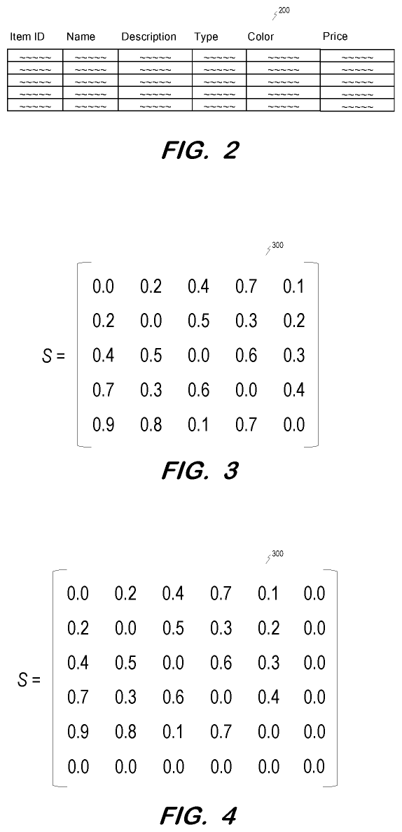

According to the present example, application 110 allows users such as user 115 to view and select items. An item may represent any good, service or other option. Each item is associated with item metadata 122 stored within database system 120. FIG. 2 is a tabular representation of portion 200 of item metadata 122 according to some embodiments. Each row of portion 200 represents a consumer product and includes a corresponding product identifier, name, description, product type, color and price. Other possible properties include dimension, weight, region of origin, etc. In a case that the items are software components such as but not limited to Application Programming Interfaces, integrations, and data services, item metadata 122 may comprise, for example, a component identifier, name, description, compatibility information, industries, and lines of business. Embodiments are not limited to either of the above two examples.

During operation of application 110, user 115 interacts with user interfaces provided by application 110. In some embodiments, such user interfaces comprise a client user interface (UI) component of software code which is downloaded to a Web browser operated by user 115 and is executed thereby. The client UI component communicates with a server component based on the user interactions.

Application 110 may thereby acquire data representing all user activities with respect to the user interfaces. These activities are recorded in user activity data 124. User activities may include but are not limited to selecting a displayed item (e.g., via a mouse-click), “liking” an item (e.g., via selection of a corresponding icon adjacent to the item), hovering a cursor over a graphic for a particular length of time, viewing a web page associated with a given item for a particular length of time, selecting a UI control, selecting a drop-down menu, and inputting text into a field.

Recommendation service 130 may operate as described herein to generate item recommendations. Recommendation service 130 may comprise a service (e.g., cloud-based) accessed by application 110 to request such recommendations, but embodiments are not limited thereto. For example, a recommendation service according to some embodiments may be integrated within application 110. By providing recommendation service 130 as a stand-alone service, recommendation service 130 may be accessed by disparate applications associated with different types of items to provide application-specific item recommendations to each of such applications. A stand-alone service also reduces overhead on the actual application which provides item recommendations to the user.

For a given application (e.g., application 110), recommendation service 130 generates similarity matrices 137 based on item metadata 122 and/or user activity data 124. Similarity matrices 137 represents graphs in which each item of item metadata 122 is represented by a node and a similarity between any two items is represented by the weight of an edge between the nodes corresponding to the items. Recommendation service 130 may therefore determine items which are most-similar to a given item based on the weights of each edge connected to the node of the given item.

Administrator 135 may access a user interface provided by recommendation service 130 to provide configuration thereof. Configuration may comprise authorizing one or more applications to access recommendation service 130. Administrator 135 may also customize the determination of item recommendations as executed by recommendation service 130. Such customizing may include, but is not limited to, customizing weights associated with each property of items metadata 122, initial user action values, and similarity score thresholds. The significance of such weights, values and thresholds will be described below.

FIG. 3 is an example of similarity matrix 300 according to some embodiments. Similarity matrix 300 represents similarities between seven items. Each (i, j) value of matrix 300 represents a similarity between the i ^{th} and j ^{th} items. The values of similarity matrix may be determined based on categorical data, text data and/or activity data as will be described below.

In some embodiments, matrices 137 include a similarity matrix determined based on item metadata only. In a case that a known user requests a recommendation based on the items, recommendation service 130 generates a new similarity matrix based on the item metadata-based matrix and on user activity data associated with the user and provides a recommendation based on the new similarity matrix. The new matrix may be stored among similarity matrices 137 for future use, if desired.

According to some embodiments, matrices 137 include a first matrix representing a first set of items and a second matrix representing a second set of items, and so on. Such an arrangement may simplify processing by avoiding similarity determinations for obviously-unrelated items. Since recommendation service 130 may be accessed by multiple applications in some scenarios, matrices 137 may include sets of application-specific matrices.

FIG. 4 illustrates matrix 300 after the addition of an item thereto. As shown, the addition of the item results in an i+1^{th} row associated with the added item and a j+1^{th} column associated with the added item. The other values of matrix 300 are unchanged, illustrating how embodiments may advantageously avoid the recalculation of similarity values in response to the addition (or subtraction) of items.

FIG. 5 is a view of matrix 500 representing user activity data 124. Matrix 500 is specific to a single user, and therefore user activity data 124 may include similar matrices for many other users. Each i^{th} row represents an i^{th} user activity and each j^{th} column represent a j^{th} item. Therefore, each value represents the count of user activity with respect to every item for a single user. Matrix 500 may be used as described below, alone or in conjunction with an item-to-item similarity matrix such as matrix 300, to determine item recommendations according to some embodiments.

An activity may be defined in any manner that is or becomes known. In some embodiments, one row may represent selections of the item and therefore the value of the i^{th} column of the row represents a number of times the i^{th} user has selected the item in a user interface of application 110. In another example, another row represents “likes”, i.e., the number of times each user has “liked” the item using a corresponding UI control. Other possible activities include but are not limited to hovering a cursor over the item for a particular length of time, viewing a Web page associated with the item for a particular length of time, and disliking an item.

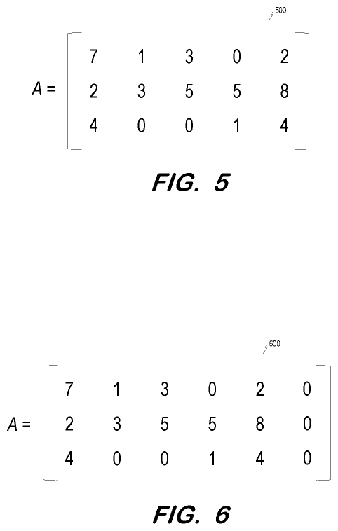

FIG. 6 illustrates matrix 500 after the addition of a user thereto. As shown, the addition of a user results in aj+1^{th} column associated with the added user. The values of the j+1^{th} column are 0 in the illustrated example because no user activity associated with the newly-added user has been detected. In some embodiments, a newly-added column of matrix 500 may include a non-zero initialization value for one or more of its rows. This initialization value may differ for each row (i.e., type of action). As described with respect to matrix 300, the addition of a user does not cause changes to the other values of matrix 500.

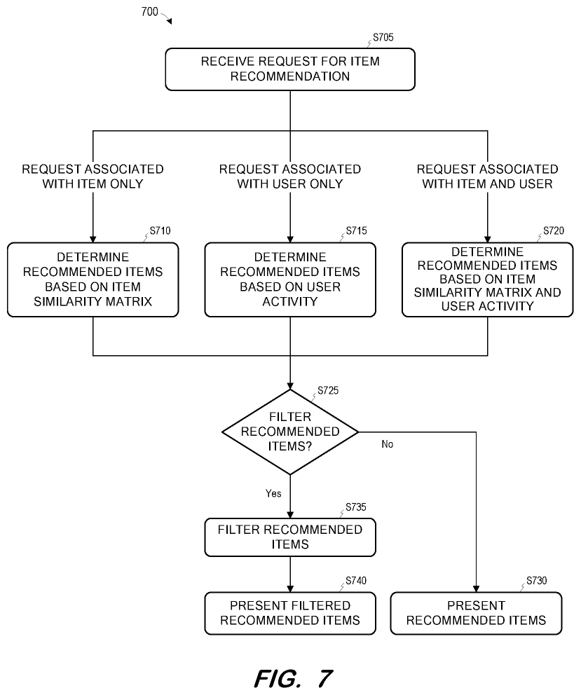

FIG. 7 comprises a flow diagram of process 700 to provide item recommendations according to some embodiments. Process 700 will be described below as if executed by recommendation service 130, but embodiments are not limited thereto.

Process 700 and all other processes mentioned herein may be embodied in processor-executable program code read from one or more of non-transitory computer-readable media, such as, for example, a hard disk drive, a volatile or non-volatile random access memory, a DVD-ROM, a Flash drive, and a magnetic tape, and then stored in a compressed, uncompiled and/or encrypted format. A processor may include any number of microprocessors, microprocessor cores, processing threads, or the like. In some embodiments, hard-wired circuitry may be used in place of, or in combination with, program code for implementation of processes according to some embodiments. Embodiments are therefore not limited to any specific combination of hardware and software.

Initially, at 5705, a request to receive an item recommendation is received. The request may be received from an application which provides items to users. The request may be triggered in response to a user action or based on any other process of the requesting application.

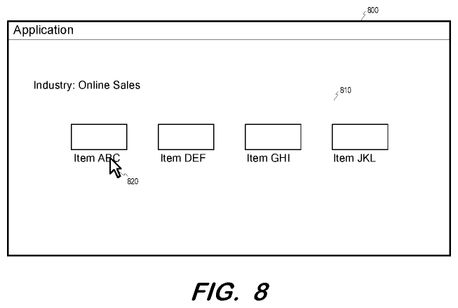

User interface 800 of FIG. 8 is an example user interface of an application according to some embodiments. User interface 800 may be presented by a Web browser of a user device operated by a user. The Web browser may execute a UI client application associated with a back-end (e.g., cloud-based) UI server application as is known in the art. Embodiments are not limited to such an application and/or architecture.

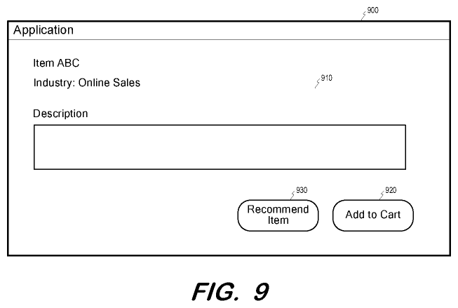

User interface 800 includes selectable controls 810, each of which is associated with a particular item. The user has moved cursor 820 over the control corresponding to Item ABC and selected the control, causing presentation of user interface 900 of FIG. 9. User interface 900 provides metadata 910 of selected Item ABC, which may be retrieved from item metadata 122 in order to generate user interface 900.

User interface 900 includes control 920 which is selectable to associate Item ABC with a shopping cart. Addition of an item to a shopping cart, as is known in the art, allows initiation of a checkout process for purchasing the item. User interface 900 also provides control 930. The user may select control 930 to issue a request for a recommendation of one or more recommended items. The request may be passed from the application to a recommendation service, where it is received at S705.

It will be assumed that the user is not logged in to the application, so the received request is associated with Item ABC only. Accordingly, at S710, recommended items are determined based on a similarity matrix which associates Item ABC with each of a plurality of other items. As described above, such a similarity matrix may provide an indicator of the similarity between Item ABC and each of the plurality of other items.

Generation of a similarity matrix based on item metadata according to some embodiments will now be described. Initially considering categorical item metadata only, the value Sᵢⱼ of the i^{th} row and j^{th} column of a similarity matrix represents a degree of similarity between the i^{th} item and the j^{th} item, and Sᵢⱼ for a given property p may be calculated in some embodiments as:

$${S}_{ij} = {S}_{ij}^{0} + \frac{( 1 - {S}_{ij}^{0} ) {w}_{p} {{t}_{ij}}^{2}}{{n}_{i} {n}_{j}}$$

where wₚ is a weight for property p, tᵢⱼ is a count of common values between the i^{th} and j^{th} items for property p, nᵢ is the total number of values of property p for item i, and nⱼ is the total number of values of property p for item j. Examples of categorical properties include type and color. By considering the total number of values of property p for a given item, Sᵢⱼ is higher between two items having identical values of property p than between either item and another item having the same values of property p as well as another value of property p.

Sᵢⱼ may be calculated for each categorical property p of item metadata 122, where S⁰ᵢⱼ is updated at each property-specific calculation. An administrator may set wₚ for each property p based on current requirements. wₚ for a same property p may differ depending on the requesting application, the tenant of the user to whom the recommendation will be presented, and any other considerations.

In addition to the above-described determination, Sᵢⱼ may be further updated based on user activity data 124. Such data may be referred to as collaboration data and reflects user activity which indicates a relation between two items. For example, a user selection of a first item which is immediately followed by a user selection of a second item may indicate a similarity between the first item and the second item. Moreover, this indication may be utilized as described below without regard to the user who performed the selections.

Updating Sᵢⱼ based on collaboration data may proceed as follows:

$${S}_{ij} = {S}_{ij}^{0} + \frac{( 1 - {S}_{ij}^{0} ) {w}_{p} ( {e}^{1 - r} - 1 )}{e - 1} \\ where \\ r = \frac{{t}_{xy}}{{t}_{m}} ,$$

t_{xy} is a time duration between a particular action (selection/view/like) taken with respect to item i by a user and the same action taken with respect to item j by the same user, tₘ is a is a time bucket which is a maximum duration for which a pair of user actions (for item x and y) is considered, and wₚ=weight for the particular action p. Accordingly, updating Sᵢⱼ based on collaboration data may be performed for each action p for which user activity data is collected. The foregoing determination exponentially dilutes time duration t_{xy} so that closer-in-time actions are given significantly more weight than farther-in-time actions.

Sᵢⱼ may be further updated based on textual data associated with each item in item metadata 122. The textual data similarity determination may be applied to non-categorical item properties including textual data, such as Name, Description, Short Text, etc. Generally, the determination may consist of determining, for each word in the textual data of a non-categorical item property of an item, a word count vector wᵢⱼ based on the frequency of the word in the property (term frequency) and the number of other items in which the word appears in the same property. The latter number may allow the assignment of less importance to words which appear in all (or many) of the other items. One example for determining wᵢⱼ for a given item is as follows:

$${w}_{ij} = {tf}_{i , j} \times log ( \frac{N}{{df}_{i}} )$$

where tf_{i,j} is the number of occurrences of i^{th} word in the j^{th} property, df_{i,j} is the number of items containing word i in the same property, and N is the total number of items.

A Cosine similarity is determined between the resulting vectors (i.e., one vector per word i) of each property of each item. Determination of the Cosine similarity generates a matrix representing the similarity between the items based on their textual data. The formula for Cosine similarity according to some embodiments is as below, where A is the word count vector for item A and B is the word count vector for item B.

$$similarity ( A , B ) = \frac{A \cdot B}{‖ A ‖ \times ‖ B ‖} = \frac{{\sum }_{i = 1}^{n} {A}_{i} \times {B}_{i}}{\sqrt{{\sum }_{j = 1}^{n} {A}_{i}^{2}} \times \sqrt{{\sum }_{j = 1}^{n} {B}_{i}^{2}}}$$

The similarity Sᵢⱼ between two items i and j based on their textual properties may then be determined as:

$${S}_{ij} = {S}_{ij}^{0} + \frac{{S}_{{a}_{ij}} \times {w}_{a} + {S}_{{b}_{ij}} \times {w}_{b} + {S}_{{c}_{ij}} \times {w}_{c} + {S}_{{d}_{ij}} \times {w}_{d} ⋯}{{w}_{a} + {w}_{b} + {w}_{c} + {w}_{d} ⋯}$$

where Sₓᵢⱼ is the similarity between items based on textual property x, and wₓ is a weight assigned to textual property x.

Returning to process 700, the determination at S710 may comprise identifying the items in a similarity matrix Sᵢⱼ calculated as described above which have the greatest similarity with the present item (i.e., Item ABC). The number of selected items may comply with any given pre-defined thresholds. The thresholds may differ based on the application, tenant, and/or item. For example, S710 may comprise identifying the items associated with the three-highest similarity scores, the items associated with the three-highest similarity scores over 30%, all the items associated with similarity scores greater than 30%, or any other suitable subset of items based on one or more thresholds.

Referring to matrix 300 of FIG. 4, it will be assumed that the third row represents Item ABC. Further assuming a “top three” threshold, the items of the first, second and fourth columns are determined at S710. Next, at S725, it is determined whether to filter the determined recommended items. For example, the request at S705 may have included one or more explicit filters (e.g., recommend items having a price lower than $50) or implicit filters such as authorization filters may exist (e.g., only present low-complexity items to anonymous user). If it is determined at S725 to not filter the recommended items, the items determined at S710 are presented at S730.

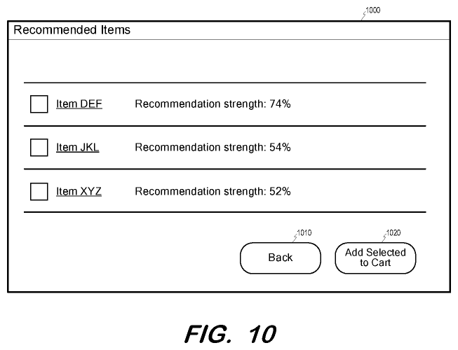

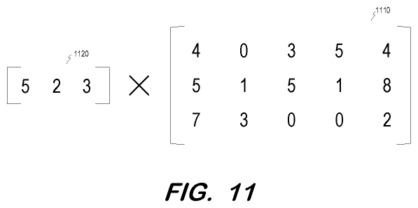

FIG. 10 is a view of user interface 1000 to present recommended items according to some embodiments. Embodiments are not limited to a user interface such as interface 1000. Interface 1000 shows three determined recommended items adjacent to selectable checkboxes and associates each recommended item with a “recommendation strength” which may represent the similarity score determined for each recommended item. Control 1010 may be selected to view previously-presented user interface 900, while control 1020 may be selected to Add any items associated with a selected checkbox to a cart as described above.

The recommended items are filtered at S735 if it is determined at S725 to apply a filter to the recommended items. According to some embodiments, recommendation service 130 queries database system 120 to determine which of the recommended items satisfies the applicable filter(s). The recommended items may therefore be filtered based on any associated item metadata 122, regardless of whether that metadata was used in the determination of the recommendation.

It will now be assumed that the request received at S705 is associated with a user only (i.e., not with an item). For example, user 115 accesses application 110 and provides credentials thereto. Based on the credentials, application 110 grants access to user 115. Next, and without reference to any particular item (such as viewing an interface of application 110 which is not associated with a specific item), user 115 operates application 110 to request item recommendations. According to some embodiments, all requests received from a user are determined to not be associated with a particular item unless the user specifically requests recommendations based on/similar to a particular item.

Flow proceeds from S705 to S715 because the received request is not associated with a particular item. At S715, recommended items are determined based on prior activity of the user. Initially, activity data 124 corresponding to the user is identified. As mentioned above, activity data 124 may provide counts of various activities conducted by a user with respect to each of several items. The activity data may be acquired to construct a user-specific matrix consisting of the j^{th} column of each activity data matrix associated with each item. Matrix 1110 of FIG. 11 is an example of such a user-specific activity matrix.

FIG. 11 illustrates action weight (AW) matrix 1200 associating a weight with each action represented by each row of matrix 1110. According to some embodiments of S715, matrices 1110 and 1120 are multiplied and the product is normalized by the sum of the weights of matrix 1120 as follows:

$$U = \frac{AW \times A}{Σ AW}$$

Matrix U is a single-row matrix containing weight-balanced values of the user activity data for each item.

It is assumed that item-to-item similarity matrix Sᵢⱼ has been previously determined and stored as described above. Matrix U is used to generate recommendation vector R including a similarity value for each item in similarity matrix Sᵢⱼ as follows:

$$R = \frac{U \times {S}_{ij}}{Σ U}$$

As previously described with respect to S710, S715 may further comprise identifying items associated with a pre-defined number of largest similarity values within vector R, associated with similarity values greater than a pre-defined percentage, or otherwise determined based on the values of vector R. These determined items may or may not be selectively filtered S735 and then presented at S730 or S740 as described above.

Returning to process 700, it is now assumed that the request received at S705 is associated with an item and with a user. For example, a user who is logged into the requesting application may request a recommendation based on a particular item.

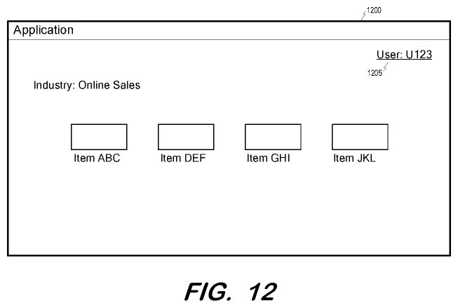

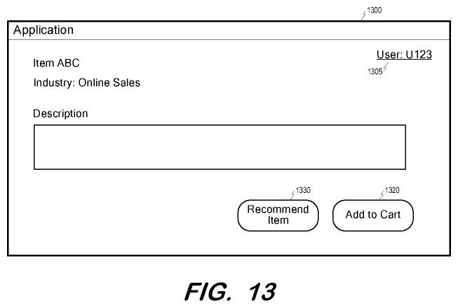

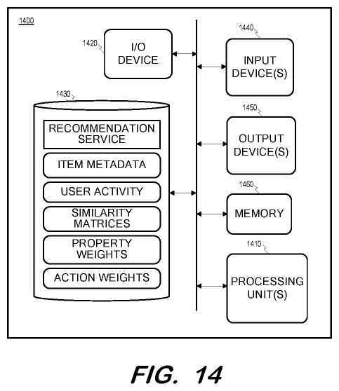

User interface 1200 of FIG. 12 is similar to user interface 800 described above. However, user interface 1200 includes identifier 1205 of a logged-in user. User interface 1300 may be displayed upon selection of Item ABC from interface 1200. Again, user interface 1300 is identical to user interface 900, but includes identifier 1305 of the logged-in user. User interface 1300 includes control 1320 selectable to associate Item ABC with a shopping cart, and control 1330 to issue a request for a recommendation of one or more items. The request may be passed from the application to a recommendation service, where it is received at S705 and includes both an indication of Item ABC and an indication of user U123.

Recommended items are determined at S720 based on an item similarity matrix and on user activity. For example, a row of similarity matrix Sᵢⱼ associated with the item of the request may be determined as described above with respect to S710, and a weighted recommendation vector R may be determined based on the user of the request as described above with respect to S715. The row and the vector may be added to generate a vector including a similarity value for each item. The recommendations may be determined from the generated vector as described above, and then selectively filtered and presented to the user as also described above.

In some embodiments, the addition of the two vectors is subjected to a weighting. Taking Rₐ as the row of similarity matrix Sᵢⱼ associated with the item of the request, R_{b} as weighted recommendation vector R, and wⱼ as a weighting, similarity vectorR_{c} may be generated at S720 as follows:

R_{c}=Rₐ+wⱼR_{b}

According to some embodiments, a recommendation service may increase wⱼ over time and/or as the quantity of collected user activity data increases.

Embodiments may also incorporate present user feedback into the determination of future recommendations. Such user feedback may be generated and received with respect to recommended items presented to a user at S730 or S740. For example, user selection of a recommended item may be detected and incorporated into future determinations of recommended items as will be described below. Conversely, user viewing of a presented recommended item for a threshold amount of time without selecting the item may be incorporated into future determinations as negative feedback. Some embodiments may provide a “Discard Recommendation” control, and user selection thereof may result in strong negative feedback incorporated into the generation of future recommendations as described below.

Generally, user feedback may result in an increase or a decrease in the similarity values used to generate a corresponding recommendation. For example, a set of items j may be recommended at S710 based on a request associated with an item i. For each item of the set which is subsequently selected by a user, corresponding values of similarity matrix Sᵢⱼ are incremented by a pre-defined amount. Negative feedback results in decreasing the corresponding values of similarity matrix Sᵢⱼ.

In a case that a set of items is recommended at S715 based on activity of a given user, the similarity value Sₖ of each recommended item in vector R may be increased (in the case of user selection of a recommended item) or decreased (in case of non-selection of a recommended item) by

$$p \cdot \frac{{U}_{j} \cdot {S}_{k}}{{Σ U}_{j}} ,$$

where p is a feedback factor. Determinations at S720 may be affected by two feedback factors, pₐ and p_{b}, where

$${p}_{a} = p \times \frac{1}{1 + {w}_{j}} \\ and \\ {p}_{b} = p \times \frac{{w}_{j}}{1 + {w}_{j}} . \\ {p}_{a}$$

may be used as described above to increase or reduce the similarity values associated with the recommended items in similarity matrix Sᵢⱼ based on user selection or non-selection of recommended items, while p_{b} may be used as described above with respect to p to increase or reduce the values associated with similarity value Sₖ of each recommended item in vector R based on user selection or non-selection of recommended items.

Hardware system 1400 may comprise a general-purpose computing apparatus and may execute program code to perform any of the functions described herein. Hardware system 1400 may be implemented by a distributed cloud-based server and may comprise an implementation of recommendation service 130 in some embodiments. Hardware system 1400 may include other unshown elements according to some embodiments.

Hardware system 1400 includes processing unit(s) 1410 operatively coupled to I/O device 1420, data storage device 1430, one or more input devices 1440, one or more output devices 1450 and memory 1460. Communication device 1420 may facilitate communication with external devices, such as an external network, the cloud, or a data storage device. Input device(s) 1440 may comprise, for example, a keyboard, a keypad, a mouse or other pointing device, a microphone, knob or a switch, an infra-red (IR) port, a docking station, and/or a touch screen. Input device(s) 1440 may be used, for example, to enter information into hardware system 1400. Output device(s) 1450 may comprise, for example, a display (e.g., a display screen) a speaker, and/or a printer.

Data storage device 1430 may comprise any appropriate persistent storage device, including combinations of magnetic storage devices (e.g., magnetic tape, hard disk drives and flash memory), optical storage devices, Read Only Memory (ROM) devices, and RAM devices, while memory 1460 may comprise a RAM device.

Data storage device 1430 stores program code executed by processing unit(s) 1410 to cause server 1400 to implement any of the components and execute any one or more of the processes described herein. Embodiments are not limited to execution of these processes by a single computing device. Data storage device 1430 may also store data and other program code for providing additional functionality and/or which are necessary for operation of hardware system 1400, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
at least one programmable processor; and
a non-transitory machine-readable medium storing instructions that, when executed by the at least one programmable processor, cause the at least one programmable processor to perform operations comprising:
determining a plurality of items, each of the plurality of items associated with a plurality of categorical attributes and one or more values of each of the plurality of categorical attributes, and with one or more textual attributes and text of each of the one or more textual attributes;
determining, for each of the plurality of categorical attributes and for each pair of the plurality of items, a number of categorical attribute values common to both items of the pair and a total number of categorical attribute values associated with each item of the pair;
determining, for each of the one or more textual attributes and for each pair of the plurality of items, a similarity between the text of each item of the pair;
determining a similarity value for each pair of items based on the number of categorical attribute values common to both items of the pair and the total number of categorical attribute values associated with each item of the pair for each of the plurality of categorical attributes, and on the similarity between the text of each item of the pair for each of the one or more textual attributes; and
determining one or more recommended items based on the determined similarity values.

2. A system according to claim 1, the operations further comprising:
receiving a request for one or more recommended items, the request identifying a first item,
wherein determining the one or more recommended items comprises identifying similarity values associated with pairs of items including the first item.

3. A system according to claim 1, the operations further comprising:
determining, for each pair of the plurality of items, a time period between user selection of each item of the pair,
wherein the similarity value for each pair of items is determined based on the time period between user selection of each item of the pair.

4. A system according to claim 3, the operations further comprising:
receiving a request for one or more recommended items, the request identifying a first item,
wherein determining the one or more recommended items comprises identifying similarity values associated with pairs of items including the first item.

5. A system according to claim 3, the operations further comprising:
receiving a request for one or more recommended items, the request identifying a first user; and
determining a count of each of a plurality of actions performed by the first user with respect to each of the plurality of items,
wherein the one or more recommended items are determined based on the determined similarity values and the count of each of the plurality of actions performed by the first user with respect to each of the plurality of items.

6. A system according to claim 5, wherein the request identifies a first item, and
wherein determining the one or more recommended items comprises identifying similarity values associated with pairs of items including the first item,
wherein the one or more recommended items are determined based on the identified similarity values and the count of each of the plurality of actions performed by the first user with respect to each of the plurality of items.

7. A system according to claim 1, the operations further comprising:
receiving a request for one or more recommended items, the request identifying a first user; and
determining a count of each of a plurality of actions performed by the first user with respect to each of the plurality of items,
wherein the one or more recommended items are determined based on the determined similarity values and the count of each of the plurality of actions performed by the first user with respect to each of the plurality of items.

8. A system according to claim 7, wherein the request identifies a first item, and
wherein determining the one or more recommended items comprises identifying similarity values associated with pairs of items including the first item,
wherein the one or more recommended items are determined based on the identified similarity values and the count of each of the plurality of actions performed by the first user with respect to each of the plurality of items.

9. A method comprising:
receiving a request for a plurality of recommended items;
determining a plurality of items, each of the plurality of items associated with a plurality of categorical attributes and one or more values of each of the plurality of categorical attributes, and with one or more textual attributes and text of each of the one or more textual attributes;
determining, for each of the plurality of categorical attributes and for each pair of the plurality of items, a number of categorical attribute values common to both items of the pair and a total number of categorical attribute values associated with each item of the pair;
determining, for each of the one or more textual attributes and for each pair of the plurality of items, a similarity between the text of each item of the pair;
determining a similarity value for each pair of items based on the number of categorical attribute values common to both items of the pair and the total number of categorical attribute values associated with each item of the pair for each of the plurality of categorical attributes, and on the similarity between the text of each item of the pair for each of the one or more textual attributes;
determining the plurality of recommended items based on the determined similarity values; and
presenting the plurality of recommended items in response to the request.

10. A method according to claim 9, wherein the request identifies a first item, and
wherein determining the one or more recommended items comprises identifying similarity values associated with pairs of items including the first item.

11. A method according to claim 9, further comprising:
determining, for each pair of the plurality of items, a time period between user selection of each item of the pair,
wherein the similarity value for each pair of items is determined based on the time period between user selection of each item of the pair.

12. A method according to claim 11, wherein the request identifies a first item, and
wherein determining the one or more recommended items comprises identifying similarity values associated with pairs of items including the first item.

13. A method according to claim 8, wherein the request identifies a first user, and further comprising:
determining a count of each of a plurality of actions performed by the first user with respect to each of the plurality of items,
wherein the one or more recommended items are determined based on the determined similarity values and the count of each of the plurality of actions performed by the first user with respect to each of the plurality of items.

14. A method according to claim 13, wherein the request identifies a first item, and
wherein determining the one or more recommended items comprises identifying similarity values associated with pairs of items including the first item,
wherein the one or more recommended items are determined based on the identified similarity values and the count of each of the plurality of actions performed by the first user with respect to each of the plurality of items.

15. A method according to claim 9, further comprising:
receiving a request for one or more recommended items, the request identifying a first user; and
determining a count of each of a plurality of actions performed by the first user with respect to each of the plurality of items,
wherein the one or more recommended items are determined based on the determined similarity values and the count of each of the plurality of actions performed by the first user with respect to each of the plurality of items.

16. A method according to claim 15, wherein the request identifies a first item, and
wherein determining the one or more recommended items comprises identifying similarity values associated with pairs of items including the first item,
wherein the one or more recommended items are determined based on the identified similarity values and the count of each of the plurality of actions performed by the first user with respect to each of the plurality of items.

17. A non-transitory medium storing processor-executable program code executable by a processing unit of a computing system to cause the computing system to:
determine a plurality of items, each of the plurality of items associated with a plurality of categorical attributes and one or more values of each of the plurality of categorical attributes, and with one or more textual attributes and text of each of the one or more textual attributes;
determine, for each of the plurality of categorical attributes and for each pair of the plurality of items, a number of categorical attribute values common to both items of the pair and a total number of categorical attribute values associated with each item of the pair;
determine, for each of the one or more textual attributes and for each pair of the plurality of items, a similarity between the text of each item of the pair;
determine a similarity value for each pair of items based on the number of categorical attribute values common to both items of the pair and the total number of categorical attribute values associated with each item of the pair for each of the plurality of categorical attributes, and on the similarity between the text of each item of the pair for each of the one or more textual attributes; and
determine one or more recommended items based on the determined similarity values.

18. A medium according to claim 17, the processor-executable program code executable by a processing unit of a computing system to cause the computing system to:
determine, for each pair of the plurality of items, a time period between user selection of each item of the pair,
wherein the similarity value for each pair of items is determined based on the time period between user selection of each item of the pair.

19. A medium according to claim 18, the processor-executable program code executable by a processing unit of a computing system to cause the computing system to:
receive a request for one or more recommended items, the request identifying a first user; and
determine a count of each of a plurality of actions performed by the first user with respect to each of the plurality of items,
wherein the one or more recommended items are determined based on the determined similarity values and the count of each of the plurality of actions performed by the first user with respect to each of the plurality of items.

20. A medium according to claim 19, wherein the request identifies a first item, and
wherein determination of the one or more recommended items comprises identification of similarity values associated with pairs of items including the first item,
wherein the one or more recommended items are determined based on the identified similarity values and the count of each of the plurality of actions performed by the first user with respect to each of the plurality of items.
